(19) United States
(12) Patent Application Publication
(10) Pub. No.: US 2002/0179380 A1
(43) Pub. Date: Dec. 5, 2002

(54) Hand brake for a motor vehicle

(76) Inventors: Philippe Bejot, Paris (FR); Eric Martin, Moisselles (FR); Thomas Pfeiffer, Reims (FR)

Correspondence Address: Leo H McCormick Jr, 2112 Mishawaka Avenue, PO Box 4721, South Bend, IN, 46634-4721, US

(21) Appl. No.: 10/110,359

(22) PCT Filed: Oct. 5, 2001
(86) PCT No.: PCT/FR01/03068

(30) Foreign Application Priority Data
Oct. 11, 2000 (FR) 00 13104

(51) Int. Cl. F16D 55/08

(52) U.S. Cl. 188/72.9

(57) ABSTRACT

Hand brake for a motor vehicle, comprising a lever (12), mounted on a support (10) so as to pivot about an axis (14), between a rest position and an active position, and a winding hub (16) for a brake-applying cable (28), said hub being fitted to the lever (12) so as to rotate about an axis (18) parallel to the axis of rotation (14) of the lever (12). An engaging spring (32), an end of which is fastened to the lever (12), is close wound on the hub (16) so as to rotationally interlock it with the lever. A tension spring (48) constantly biases a free end (36) of the engaging spring in the direction of contraction of the latter on the hub (16).

This invention relates to a hand brake for a motor vehicle, which is mainly used as a parking brake.

Most generally, a hand brake for a motor vehicle comprises a pivotally-mounted lever inside the passenger space, near the driver's seat, so as to exert a tensile force on a cable controlling the application of both rear brakes, such lever being fitted with means provided for the locking of the brakes in the active position, and with unlocking means too.

In a well-known implementation, the lever comprises rotationally-guiding and supporting means for a hub, on which fastening means are located for the attachment of an end of the brake cable, as well as a sheave or an annular groove for the winding of part of the cable. Automatic adjusting means for the cable tension comprise a return spring, connecting the hub to the lever and constantly rotationally biasing the hub in the direction of the winding of the cable onto the sheave or into the above-mentioned annular groove. Rotationally-coupling or engaging means are also provided for a joint rotation of the lever and the hub, as soon as the lever leaves its rest position, and also for their disengaging, in the same way, when the lever is returned to its rest position.

In a particularly simple and effective manner, such engaging means consist of a spring, close coiled on the hub and an end of which is fastened to the lever, whereas its free other end bears on a stationary stop, when the lever is in the immediate vicinity to its rest position, with the result that the spring is relaxed on the hub and that the hub may be released so as to rotate freely. Thus, when the lever is in its rest position, the hub, which is capable of rotating in relation to the lever and which is rotationally biased by its return spring in the direction of the cable winding operation, exerts constantly, on the cable, a tension having a determined value.

Though such an arrangement actually answers the purpose satisfactorily, under the conditions in which the hand brake is most frequently used, however it has been established that, if the lever is quickly moved out of its rest position, the engaging spring would not always contract at once, and that it could slip on the hub, which means that it does not operate properly and that the hand brake is only partially applied.

The object of this invention consists, more particularly, in coping with the above-mentioned disadvantage.

With this object in view, the invention provides a hand brake for a motor vehicle, comprising

a lever, mounted on a support so as to pivot about an axis, between a rest position and an active position, in which braking means are applied;

locking and unlocking means for the lever as regards its active position;

a hub, fitted to the lever so as to rotate about an axis parallel to the axis of rotation of the lever, said hub comprising means for the attachment of an end of a brake cable, and spring-loaded means biasing the hub into a rotational motion about its axis, in the winding direction of the cable; and

an engaging spring, which is close wound on the hub and fastened at one end to the lever, whereas the other end of the spring bears on a stationary stop so as to relax the spring and enable the hub to rotate in relation to the lever when said lever is in its rest position and, when the lever leaves its rest position, said other end of the spring separates from the stationary stop and enables the spring to contract on the hub, thus rotationally interlocking the latter with the lever,

characterised in that it comprises means which constantly bias said other end of the engaging spring in the direction of its contraction.

Thanks to the latter means, the spring may be contracted on the hub as soon as the lever leaves its rest position, even if such motion is quite swift, the contraction of the spring resulting in the rotational coupling of the lever with the hub, and therefore in a tensile force being exerted on the brake-actuating cable. When the lever, after having been moved to its active position, is returned to its rest position, said other end of the engaging spring comes back to its bearing position on the stationary stop, the effect of which is to relax the engaging spring and release the hub for a free rotation relatively to the lever.

Preferably, the means, which bias said other end of the engaging spring towards the contracted position, are resiliently deformable means, mounted between said other end of the spring and the lever.

In a preferred embodiment of this invention, such resiliently deformable means comprise a tension spring.

Other features and advantages of the present invention will be apparent from the following detailed description, by way of example and by no means as a limitation, when taken in conjunction with the accompanying drawings, in which:

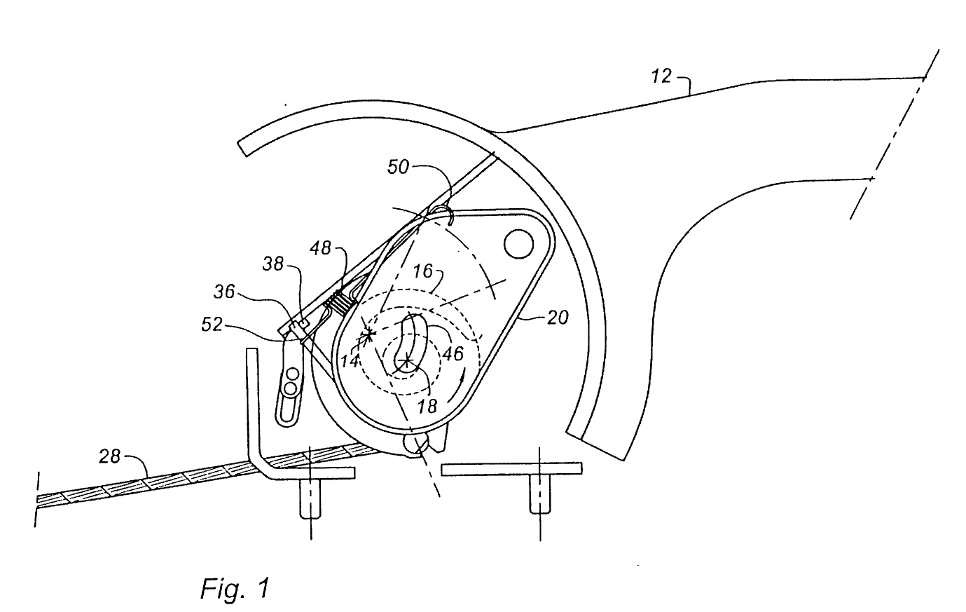

FIG. 1 is a schematic partial elevation view of a hand brake according to this invention; and

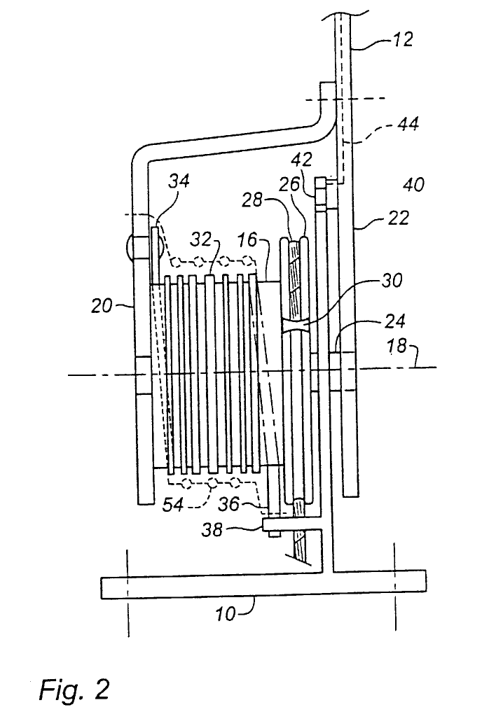

FIG. 2 is a larger-scale schematic partial side view of the hand brake of FIG. 1.

In the drawings, the reference numeral 10 designates a fastening support for a hand brake lever 12 in the passenger space of a motor vehicle, near the driver's seat. The lever 12 is mounted on the support 10 so as to pivot about an axis 14 and it comprises rotationally-guiding and supporting means for a cylindrical hub 16, which is fitted to the lever 12 so as to rotate about an axis 18 parallel to the axis of rotation 14 of the lever 12 and offset in relation to it.

In the present embodiment, the lever 12 has, at its lower part, two flanges 20, 22 to which a shaft 24, supporting the hub 16, is journaled.

A spiral return spring (shown in dotted lines) is housed inside the cylindrical hub 16 and fastened, by its radially-inner end, to the shaft 24 and, by its radially-outer end, to the hub 16. This return spring biases constantly the hub 16 in the direction of rotation indicated by the arrow in FIG. 1. At one end, the hub 16 exhibits a sheave 26 or an annular groove for the winding of a brake-applying cable 28, and end of which is fastened at 30 to the sheave 26 and the other end of which is connected to a brake application mechanism of a known type. The direction in which the return spring biases the hub 16 into a rotational motion corresponds to the winding of the cable 28 onto the sheave 26, so that the hub 16 may exert, under the action of its return spring, a tension of a determined value on the cable 28.

Rotationally-coupling or engaging means are provided between the lever 12 and the hub 16 and they consist of a spring 32, which is close wound on the hub 16, such spring comprising substantially contiguous turns having e.g. a rectangular or a square cross-section, whereas one 34 of its ends is fastened to the lever 12, for instance to the flange 20 at the end of the hub opposite the sheave 26. The other end 36 of the spring 32 is free and extends tangentially outwards in relation to the hub 16 so as to bear on a stationary stop 38 on the support 10, when the lever 12 is returned to its rest position. Near said position, the abutting of the spring end 36 against the stationary stop 38 causes the spring to slack on the hub 16, as a result of which the hub 16 can rotate in relation to the lever 12.

When the lever 12 is shifted from its rest position towards its operating position, the spring end 36 is separated from the stationary stop 38, which enables the spring 32 to contract resiliently on the hub 16, thus rotationally interlocking the latter with the lever 12.

Therefore, the swivelling motion of the lever 12 towards its operating position results in the rotational motion of the hub 16 about the axis of rotation 14 of the lever 12 on the support 10 and a tensile force is exerted on the cable 28 so as to apply the brakes.

Locking means, intended to arrest the lever 12 in the active position, are disposed between said lever and the support 10 and they comprise e.g. a toothed segment 40, formed on the support 10, and a spring-loaded pawl 42, carried by the lever and gearing with the teeth of the toothed segment 40, thus enabling the lever 12 to rotate about the axis 14, from the rest position towards the active position, but keeping it from rotating in the reverse direction. An unlocking rod 44 is mounted inside the lever 12 and is operated by a push button situated at the free end of the lever, so as to make the pawl 42 pivot and disengage from the toothed segment 40 when the push button is depressed, thus returning the lever 12 to its rest position.

It has been mentioned herein before that a swift motion of the lever 12 from its rest position to its active position may happen not to be followed by an immediate contraction of the spring 32 on the hub 16, which brings about a rotational motion of the hub 16 about its axis 18 and its slipping in relation to the spring 32. When the angular range of freedom of the lever 12 is restricted, as schematically illustrated in FIG. 1, for instance when the end of the support shaft 24 of the hub 16 is guided within a curved slot 46 in the support 10, such slipping may result in an incomplete application of the hand brake.

In accordance with this invention, such disadvantage is removed when the free end 36 of the spring 32 is connected to the lever 12 through resiliently deformable means 48, such as a tension spring, in such a way that the free end 36 of the spring 32 may be constantly biased in the contracting direction of the spring 32 on the hub 16.

In the illustrated example, an end 50 of the tension spring 48 is hung on the flange 20 of the lever 12, e.g. near the attachment of the other end 34 of the spring 32. The other end 52 of the tension spring 48 exhibits the shape of a hook, engaging a slot or a small groove in the end 36 of the spring 32.

Thus, as soon as the lever 12 leaves its rest position, the free end 36 of the spring 32 is biased in the contracting direction of the spring on the hub 16, which prevents the above-mentioned slipping motion between the spring 32 and the hub 16.

The spring 48 does not have to exert a high tensile force on the free end 36 of the spring 32: as a matter of fact, a tension in the order of 10 N or even less is enough.

As an alternative, the tension spring 48 may be replaced by a torsion spring 54, schematically shown in dotted lines in FIG. 2, such spring being wound on the outside of the engaging spring 32 in the opposite direction to that of the spring 32, while being fastened or resting, by its ends, on the flange 20 and on the end 36 of the spring 32 so as to conduce to the contraction of the latter on the hub 16, when the swivelling motion of the lever 12 causes the end 36 of the spring 32 to separate from the stop 38.

Thus, through simple inexpensive means, and moreover adaptable to pre-existent hand brakes, the present invention ensures the reliable operation of the hand brake whatever the actuation conditions of the latter may be.

1. Hand brake for a motor vehicle, comprising
a lever (12), mounted on a support (10) so as to pivot about an axis (14), between a rest position and an active position, in which braking means are applied;
a hub (16), fitted to the lever (12) so as to rotate about an axis (18) parallel to the axis of rotation (14) of the lever (12), said hub comprising means (30) for the attachment of an end of a brake-applying cable (28), and spring-loaded means biasing the hub (16) into a rotational motion about its axis (18), in the winding direction of the cable (28); and
an engaging spring (32), which is close wound on the hub (16) and fastened at one end (34) to the lever (12), whereas the other end (36) of the spring bears on a stationary stop (38) so as to relax the spring and enable the hub (16) to rotate in relation to the lever when said lever is in its rest position and, when the lever leaves its rest position, said other end (36) of the spring separates from the stationary stop and enables the spring (32) to contract on the hub (16), thus rotationally interlocking the latter with the lever, characterised in that it comprises means (48, 54) which constantly bias said other end (36) of the engaging spring in the direction of its contraction.

2. Hand brake according to claim 1, characterised in that said means, which constantly bias said other end (36) of the engaging spring in the direction of contraction, comprise resiliently deformable means (48, 54).

3. Hand brake according to claim 1 or 2, characterised in that said means, which constantly bias said other end (36) of the engaging spring (32) in the direction of contraction, are arranged between said end (36) of the engaging spring and the lever (12).

4. Hand brake according to any one of the preceding claims, characterised in that said means, which constantly bias said other end (36) of the engaging spring in the direction of contraction, comprise a spring (48, 54).

5. Hand brake according to claim 4, characterised in that said spring (48) is a tension spring.

6. Hand brake according to claim 4, characterised in that said spring (54) is a torsion spring, wound about the engaging spring (32).

7. Hand brake according to claim 6, characterised in that said torsion spring (54) is wound in the opposite direction to that of the engaging spring (32).

8. Hand brake according to any one of claims 4 to 7, characterised in that the ends of the spring (48, 54) are hung or resting on said other end (36) of the engaging spring and on the lever (12).
